(19) United States
(12) Patent Application Publication
(10) Pub. No.: US 2018/0101797 A1
(43) Pub. Date: Apr. 12, 2018

(54) SYSTEMS AND METHODS FOR IMPROVING SALES PROCESS WORKFLOW

(71) Applicant: LiveHive, Inc., San Jose, CA (US)

(72) Inventors: Frederick Lloyd Mueller, Los Altos, CA (US); Thomas Eugene SAULPAUGH, San Jose, CA (US); Jonathan Lee BRINK, San Jose, CA (US); Suresh BALASUBRAMANIAN, Sunnyvale, CA (US)

(21) Appl. No.: 15/729,024

(22) Filed: Oct. 10, 2017

Related U.S. Application Data
(60) Provisional application No. 62/406,177, filed on Oct. 10, 2016.

(51) Int. Cl. G06Q 10/06; G06Q 30/02

(52) U.S. Cl. CPC G06Q 10/0633; G06Q 10/06393; G06Q 10/06398; G06Q 30/0201

(57) ABSTRACT

Presented are systems and methods for analyzing a sales process workflow to increasing sales productivity. In embodiments, the system comprises a sales person activity recorder that monitors and records sales-related data according to one or more data categories from one or more data sources; a prospect activity recorder coupled to the sales person activity recorder, the prospect activity recorder monitors and records an interaction associated with a sales prospect; and an analytics processor coupled to the sales person activity recorder, the analytics processor synchronizes sales-related data from one or more data sources, and analyzes, based on at least the interaction, some or all of the data to obtain a result, the analytics processor generates and outputs, based on the analysis, a result that comprises at least one of a progress report, a ranking of prospects, and a sales performance score.

### CROSS REFERENCE TO RELATED PATENT APPLICATIONS

The present application claims priority benefit, under 35 U.S.C. § 119(e), to co-pending and commonly-assigned U.S. Patent Application No. 62/406,177 filed on Oct. 10, 2016, entitled “Systems and Methods for Improving Sales Process Workflow,” and listing as inventors Frederick Lloyd Mueller, Thomas Eugene Saulpaugh, Jonathan Lee Brink, and Suresh Balasubramanian, which application is herein incorporated by reference as to its entire content. Each reference mentioned in this patent document is incorporated by reference herein in its entirety.

### TECHNICAL FIELD

The present disclosure relates to information handling systems such as networking devices. More particularly, the present disclosure related to systems and methods for monitoring, detecting, recording, and analyzing sales-related events, such as emails and phone calls, using one or more information handling systems.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIGURE (“FIG.”) 1 illustrates a sales analysis system according to various embodiments of the present disclosure.

FIG. 2 illustrates an analytics processor according to various embodiments of the present disclosure.

FIG. 3 is a flowchart of an illustrative process for analyzing a sales process workflow in accordance with various embodiments of the present disclosure.

FIG. 4 illustrates an exemplary analytics closing report according to various embodiments of the present disclosure.

FIG. 5 illustrates an exemplary analytics converting report according to various embodiments of the present disclosure.

FIG. 6 illustrates an exemplary analytics prospecting report according to various embodiments of the present disclosure.

FIG. 7 illustrates an exemplary analytics qualifying report according to various embodiments of the present disclosure.

FIG. 8 illustrates an exemplary analytics coaching report according to various embodiments of the present disclosure.

FIG. 9 illustrates an exemplary sales campaign effectiveness report according to various embodiments of the present disclosure.

FIG. 10 depicts a block diagram of an information handling system according to embodiments of the present invention.

### DETAILED DESCRIPTION OF THE PREFERRED EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method on a tangible computer-readable medium.

Components, or modules, shown in diagrams are illustrative of exemplary embodiments of the invention and are meant to avoid obscuring the invention. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” or “communicatively coupled” shall be understood to include direct connections, indirect connections through one or more intermediary devices, and wireless connections.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of the above-noted phrases in various places in the specification are not necessarily all referring to the same embodiment or embodiments.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated. Furthermore, the use of memory, database, information base, data store, tables, hardware, and the like may be used herein to refer to system component or components into which information may be entered or otherwise recorded.

Furthermore, it shall be noted that: (1) certain steps may optionally be performed; (2) steps may not be limited to the specific order set forth herein; (3) certain steps may be performed in different orders; and (4) certain steps may be done concurrently.

Furthermore, it shall be noted that embodiments described herein are given in the context of sales events, but a person skilled in the art will recognize that the teachings of the present disclosure are not limited to sales applications for salespeople, marketing people, or a customer support people, but may equally be applied in other contexts.

In this document, the term “prospect” refers to any person of interest to someone using the invention, such as salesperson. “Salesperson” refers to any person using the present invention. As used herein, the terms “action,” “interaction,” and “activity” comprise opening an email or voicemail, viewing an attachment, downloading an attachment, printing an attachment, forwarding an attachment, clicking on a link within an email, replying to an email, an amount of time spent on a page or slide in the attachment, or any combination thereof. It is understood that any one or more of the foregoing is sufficient for the interaction and is not limited to any order. The term “template” refers to pre-constructed email or voicemail templates that may include any type of text, images, web links, and attachments, such as Microsoft Word documents, Microsoft PowerPoint documents, Microsoft Excel documents, Adobe PDF documents, and any other known document format.

FIG. 1 illustrates a sales analysis system according to various embodiments of the present disclosure. System 100 comprises prospect activity recorder 102, pre-processor 104, database 106, analytics processor 108, salesperson activity recorder 110, and analytics display 112. Prospect activity recorder 102 is designed to monitor, detect, and record data associated with a prospect. Salesperson activity recorder 110 monitors, detects, and records data associated with a salesperson.

In operation, in embodiments, prospect activity recorder 102 detects and/or gathers inputs 122 related to a prospect, such as sales-related activities performed by the prospect. Activities may include, for example, time, manner, and recency of opening an email, clicking a link/URL in an email, opening and viewing pages of an attachment, replying to an email, forwarding an email to one or more recipients, and the like.

In embodiments, prospect activity recorder 102 may be implemented as a pixel detector that monitors email traffic and records stop signals based on, e.g., a prospect accessing a “sent” email folder. Similarly, prospect activity recorder 102 may monitor phone traffic, digitize audio signals, and apply metadata (timestamp, location data, etc.) to the detected data.

In embodiments, prospect activity recorder 102 and/or salesperson activity recorder 110 converts the gathered data, e.g., into a format suitable for storage in database 106. Gathered information may be stored together with the content of an email, dates and topics of scheduled meeting 160, notes regarding the contents of phone call 162, and the like.

In embodiments, prior to storing gathered activity data 132, 136 in database 106, all or a portion of activity data 132, 136 generated by prospect activity recorder 102 and/or salesperson activity recorder 110 may be input to pre-processor 104. Pre-processor 104 may filter and/or sort activity data 132 by event, date, location, and other parameters such as user-defined parameters.

In embodiments, activity data 132, 136 is filtered and processed to avoid invalid data. Data may be invalid, for example, for the following reasons:

1) the salesperson reads an email from the salesperson's own Sent folder; 2) the recipient of the email opened it in a preview window and also in a new window, so that same email is detected as being read twice when, in fact, it was read only once; 3) it is the email system that receives the email and initially opens it to determine whether it contains SPAM, retrieve images in the email, etc.; and 4) the recipient opens the email more than once within a relatively short time span (e.g., 5 minutes), so that more than one occurrence of opening is detected even if the email is read only once.

Once activity data 132, 136 is pre-processed and filtered it (i.e., valid data) may be stored in database 106. In embodiments, upon receiving activity data 132, 136, pre-processor 104 assigns one or more labels to activity data 132, 136, for example, by accessing clock or counter 142 and timestamping an activity, or by accessing location detector 144 and assigning an IP address or URL to an activity. It is understood that labeling may be performed using any labeling technique known in the art and comprises counting a set or sub-set of activities and events. In embodiments, pre-processor 104 categorizes activity data 132, 136 applying metadata associated with activity data 132, 136. The gathered and/or filtered activity data 132, 136 may be stored with or without labeling/metadata in database 106 from, where it may be accessed by analytics processor 108.

A person of skill in the art will appreciate that database 106 maybe embedded within centralized or distributed memory (not shown). Stored data may comprise the identity of the prospect who performed each action or caused each action to be performed; a link that the prospect clicked; an attachment that the prospect viewed; a time that passed while the prospect had an attachment open.

In embodiments, once an email having an attachment is forwarded to a recipient and the attachment is opened, the recipient is prompted to enter an email address (e.g., in a dialogue box) that is saved, and if the recipient replies to an email, the content of the reply email is stored in database 106.

In embodiments, when a salesperson makes a phone call, the action/event is stored in database 106 (e.g., in a data warehouse), together with, for example, the identity of the person contacted, a timestamp, a duration of the phone call, and notes about the content of the phone call.

In embodiments, analytics processor 108 accesses database 106 and retrieves stored data to calculate one or more sales analytics. Data retrieval may be performed according to one or more data categories. For example, analytics processor 108 may retrieve and synchronize Definitions from a SmartPath system 152; a list of email templates and phone scripts 154; data from a Customer Relationship Management (CRM) system 156 (e.g., contact names, company names, and estimated values of sales opportunities); data from a Marketing Automation system (e.g., actions taken by a sales prospect such as responding to previous marketing emails, clicking on links in emails sent by the Marketing Automation system); and any combination thereof.

In embodiments, analytics processor 108 may perform calculations at scheduled intervals, e.g., once per day, on request, or in real-time as new data appears in sales analysis system 100, e.g., in response to prospect activity recorder 102 or salesperson activity recorder 110 modifying data in or adding new data to database 106.

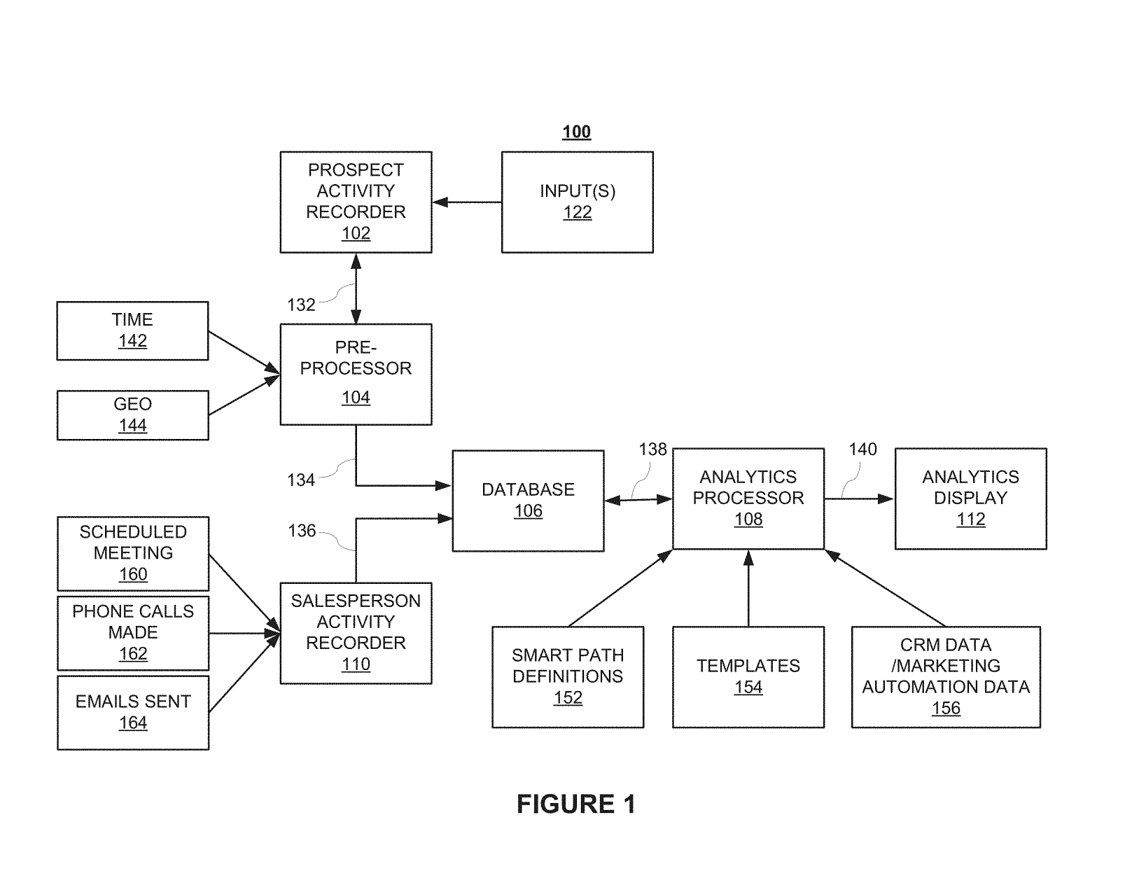

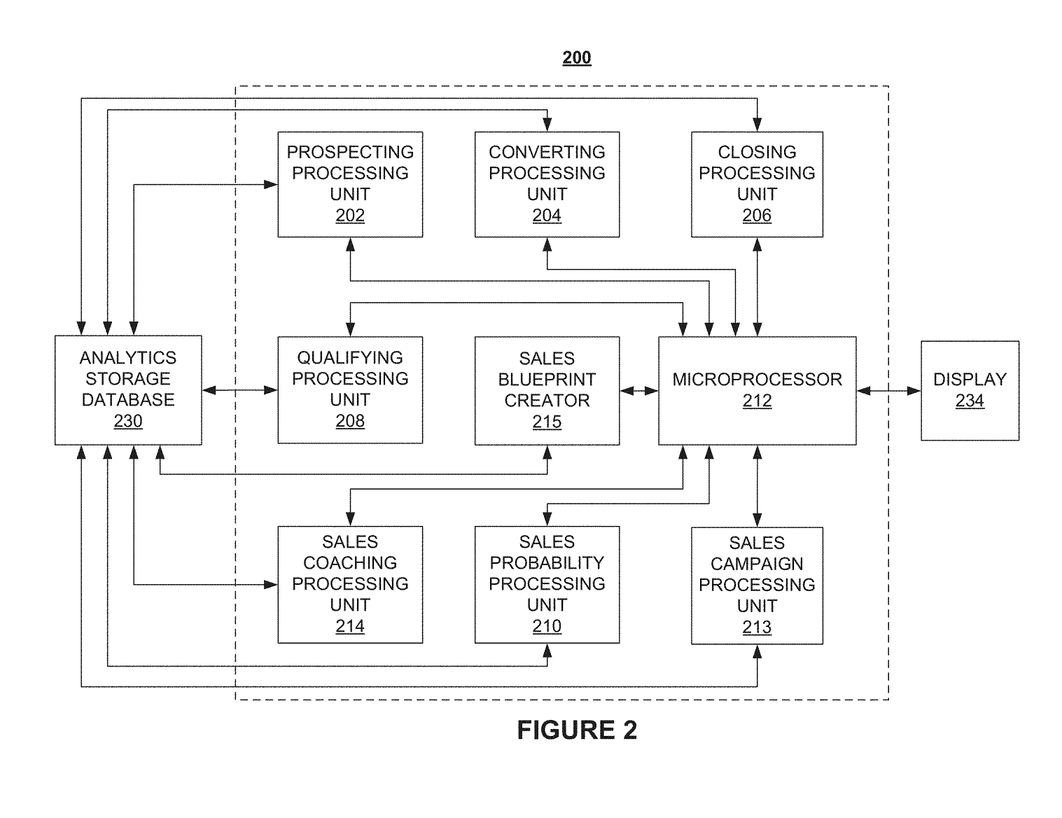

In embodiments, analytics display 112 graphs the result of the calculations performed by analytics processor 108. Examples of calculations and results are discussed with regard to FIG. 2 and FIG. 4-10 below. Output 140 of analytics processor 108 may be formatted and displayed on display 112. In embodiments, analytics display 112 displays analytics data using interactive graphs and tables that allow a user to customize details shown in a graph or table, for example, to modify a data set or change a timeframe.

FIG. 2 illustrates an analytics processor according to various embodiments of the present disclosure. Analytics processor 200 comprises prospecting processing unit 202, converting processing unit 204, closing processing unit 206, qualifying processing unit 208, sales blueprint creator 215, microprocessor 212, sales coaching processing unit 214, sales probability processing unit 210, and sales campaign effectiveness processing unit 213. Similar to analytics process 180 shown in FIG. 1, analytics processor 200 in FIG. 2 may receive data from analytics database 230 that comprises one or more data sources, such as SmartPath, templates, CRM data, and Marketing Automation data. Analytics processor 200 may be coupled to analytics display 234 to display an output of analytics processor 200. Microprocessor 212 comprises an accelerator (not shown) that performs calculations for one or more units within analytics processor 200.

In operation, in embodiments, analytics processor 200 receives or retrieves sales-related data (e.g., recorded prospect and/or salesperson activity) from analytics database 230 and analyzes at least a portion of the data by applying a set of rules or metrics to output a result. Exemplary results are scores (e.g., sales performance scores), progress reports, and ordered lists (e.g., prospect rankings).

In embodiments, analytics processor 200 analyzes the sales-related data by combining and correlating data from one or more sources and applying weighting factors to subsets or subcategories of data, for example, data related to one particular type of activity.

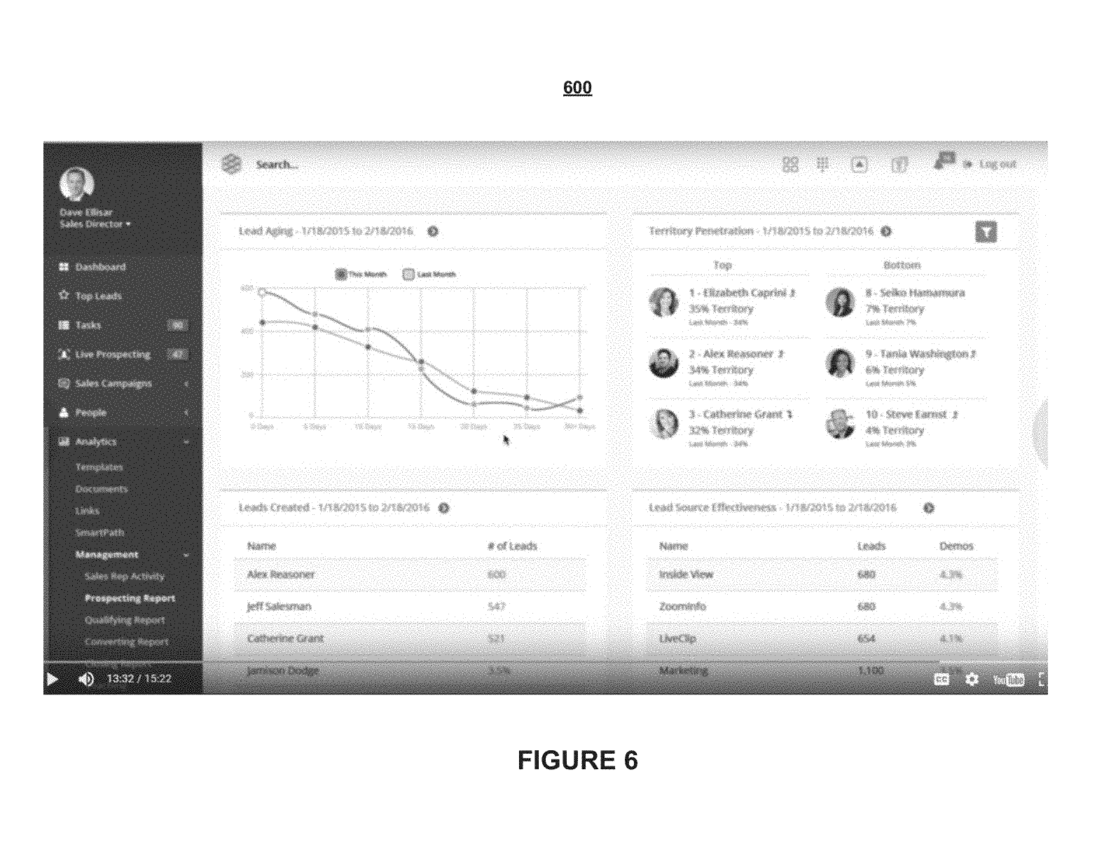

Prospecting processing unit 202 measures the quantity and quality of prospecting efforts by salespeople. Prospecting refers to the process of finding and adding new sales prospects. Prospecting is an important first step in the sales process. If relatively few new prospects are added, sales are likely to decline in a later timeframe, thus, negatively impacting the sales process workflow. In embodiments, prospecting processing unit 202 assesses new prospects, e.g., for a specified timeframe, to quantify one or more of the following: the total number of new prospects added; new prospects added by each salesperson, new prospect total from different prospect sources (i.e., prospect source effectiveness), and quality of prospects as measured, for example, by the number of prospects scheduled for a product demonstration or the number of prospects that replied to an email or made a phone call. An exemplary report 600 generated according to various embodiments of the present disclosure using prospecting processing unit 202 is displayed in FIG. 6. Analytics prospecting report 400 may be used by a sales manager to view individual salesperson's progress toward achieving a target number for adding new prospects.

Converting refers to the process of determining whether a prospect's activities indicates an interest in a product or service sufficient to justify a categorization as an “opportunity.” Once converting processing unit 204 categorizes a prospect as an opportunity, it may, for example, visually flag the opportunity as such for the salesperson, e.g., on an interactive display subject to an override by the salesperson. In embodiments, converting processing unit 204 retrieves prospect activity data, e.g., for a specified timeframe, and determines one or more of the following:

1) New Opportunities—This determination is based on prospects' records marked as opportunity for the specified timeframe and, in embodiments, results in an output that represents a count of prospects' records broken down by salesperson and/or as a total for a sales team. Converting processing unit 204 may compare the number of new opportunities to previous, similar timeframes, for example, to determine a trend for the number of total conversions and/or the rate of conversion.

2) Touches to Opportunity—For each opportunity that is retrieved from one or more databases, converting processing unit 204 may determine how many “touches” (i.e., emails, phone calls, other communications/contacts) occurred until the salesperson marked a particular prospect as an opportunity. In embodiments, converting processing unit 204 determines a number of touches from the salesperson's activity records for emails and phone calls for the prospect that was converted to an opportunity during the specified timeframe. The number of touches may represent a metric for the average number of touches it takes to convert a prospect during a specified timeframe, and may serve as a tool for designing sales campaigns in a manner such as to ensure that a sales campaign has enough touches to be effective.

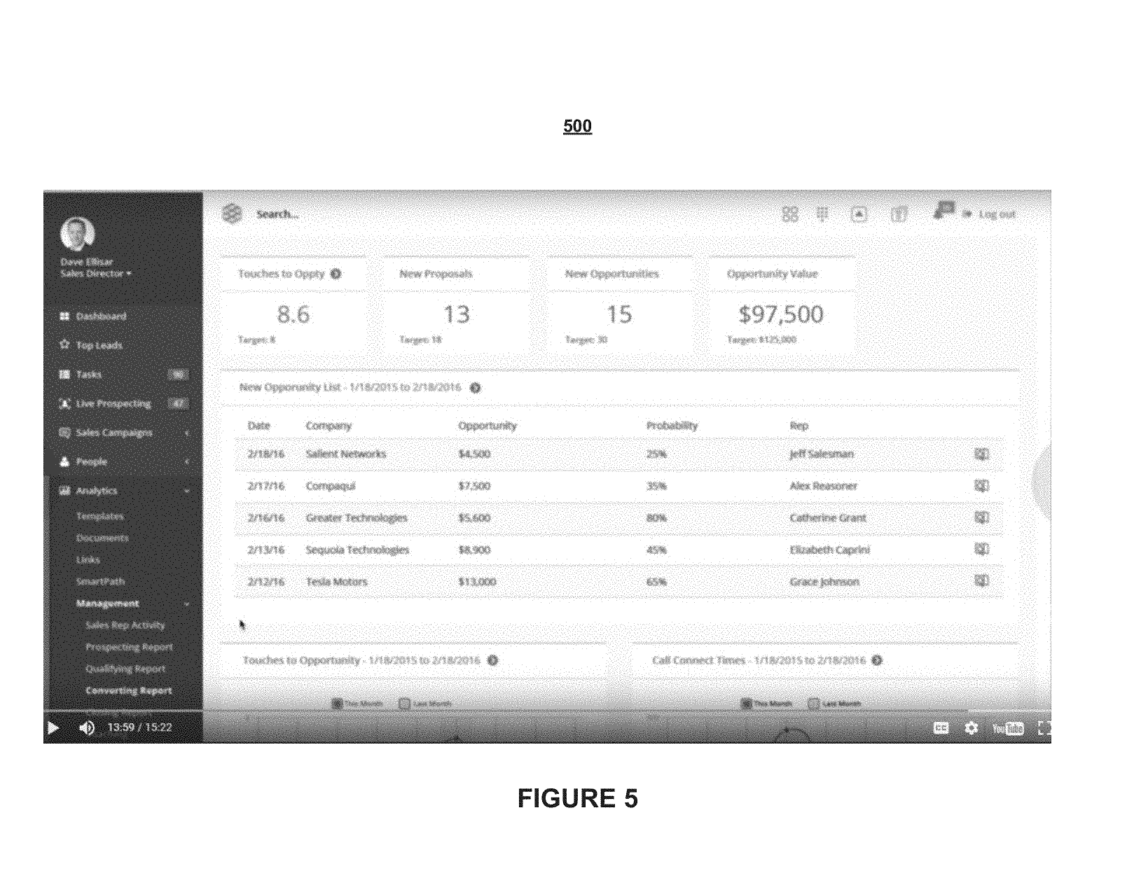

3) Dollar Value—In embodiments, converting processing unit 204 uses dollar amounts (e.g., estimated by a salesperson) for a number of sales prospects that have been converted to opportunities during a specified timeframe to calculate an average dollar amount. The average dollar amount may be compared to amounts in previous timeframes to allow a determination of whether the average value of a sales opportunity is increasing or decreasing. In embodiments, converting processing unit 204 retrieves dollar value data from an external system, such as a CRM system, and merges the data with records in an internal database. An exemplary report 500 generated according to various embodiments of the present disclosure using converting processing unit 204 is displayed in FIG. 5. Analytics converting report 500 may allow a manager to monitor how a sales team is performing in converting prospects to opportunities. In FIG. 5, metrics are shown for the sales team and are compared to target values.

Closing refers to completed sales. A salesperson may report, e.g., in LiveHive or in an external system, such as a CRM that is connected with LiveHive, the date and time a sale has closed and the corresponding sales amount. In embodiments, closing processing unit 206 retrieves sales records of completed sales for a specified time period to determine one or more of the following:

1) Deals closed—The total number of sales completed in the specified time period.

2) Dollar value—In embodiments, closing processing unit 206 retrieves from the sales records the dollar values of completed sales to calculate a total dollar value for the specified time period.

3) Average deal size—An average dollar amount for sales completed in the specified time period.

Touches to close—For each retrieved closed sale, closing processing unit 206 may use, e.g., a salesperson's activity record, to determine how many touches occurred until a salesperson marked an opportunity as closed. The number of touches may represent a metric for determining the average number of touches it takes to close an opportunity, i.e., to convert an opportunity to a sale. This number may be used to estimate the average effort to close a sale.

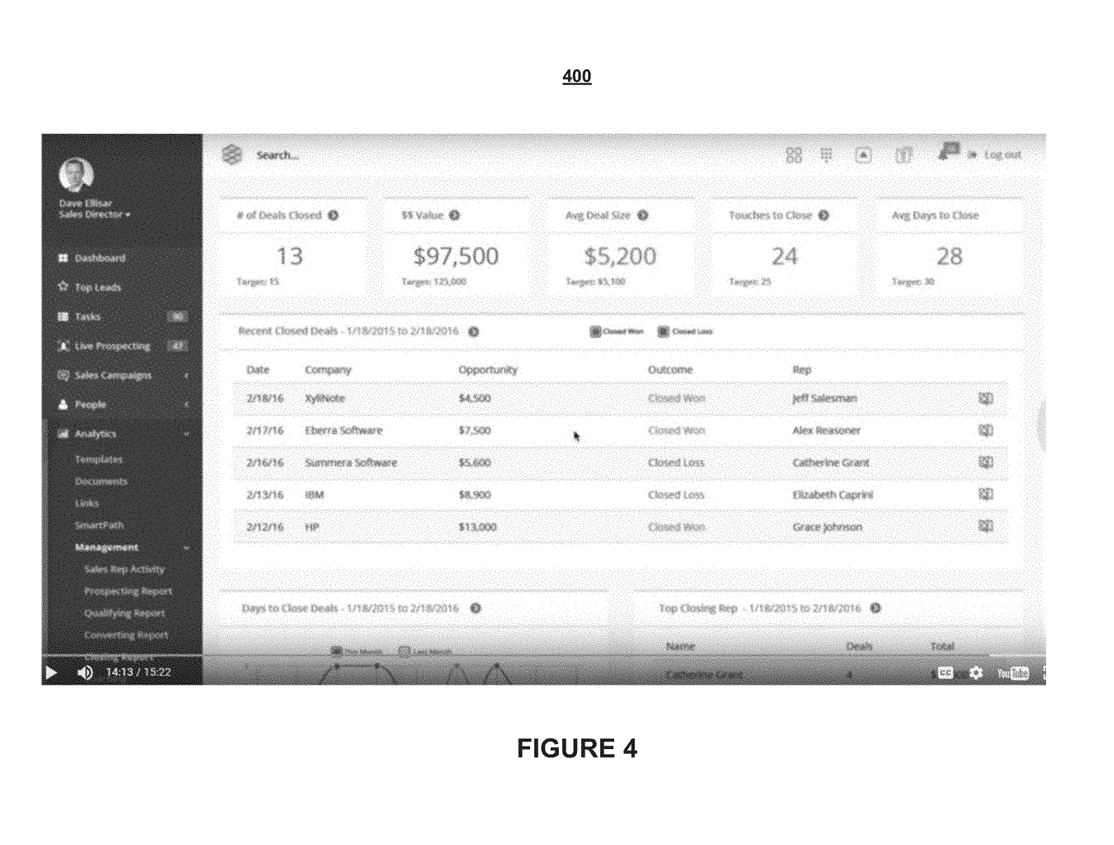

4) Days to Close—In embodiments, closing processing unit 206 retrieves completed sales data from sales records for a specified time period and determines therefrom an average difference in time between a prospect being marked as an opportunity and the opportunity being marked as a closed sale. The resulting average difference represents an estimate of the lead time for closing the sale and, in embodiments, the average difference is used to estimate how many opportunities in the sales process workflow are likely to close by a certain date. Based on these estimates a sales organization may forecast future sales. An exemplary report 600 generated according to various embodiments of the present disclosure using closing processing unit 206 is displayed in FIG. 4. Analytics closing report 600 may provide an overview of progress regarding recent sales opportunities that were won or lost and progress toward a monthly or quarterly goal.

Qualifying refers to identifying prospects that have a need for a product or service a salesperson is selling. In embodiments, qualifying processing unit 208 retrieves prospects, e.g., for a specified timeframe, and determines one or more of the following:

1) Best Time to Email—In embodiments, based on salesperson records of emails sent to prospects, qualifying processing unit 208 determines a time of day that corresponds to the greatest percentage of sent emails are opened. This may be accomplished by grouping the time of day for all sent emails into time intervals, e.g., one-hour intervals, and calculating, for each grouping a percentage of emails that were opened, so that the time interval having the highest percentage is reported as the Best Time to Email. In embodiments, as a more stringent metric, rather examining a salesperson records for opened emails, when determining the Best Time to Email, qualifying processing unit 208 examines how many emails resulted in an email response.

2) Best Time to Call—In embodiments, qualifying processing unit 208 retrieves sales records of phone calls made to a prospect, e.g., a specified time period, and determines therefrom a time at which calls resulted in the greatest percentage of phone conversations. As with the Best Time to Email, qualifying processing unit 208 may group the time of day for all phone calls into time intervals to calculate, for each grouping, a percentage of phone calls that were return or resulted in a live conversation. In embodiments, the time interval with the highest success rate is reported as the Best Time to Call.

3) Call Connect Rate—This is a metric that describes the percentage of a salesperson's phone calls made to a prospect that resulted in a live conversation.

4) Touches to Demo—In embodiments, a salesperson's activity scheduled demonstrations during a specified timeframe is used to determine an average of touches/scheduled demonstrations as a metric of the average number of touches to setup a product demonstration. This metric is used to estimate the effort to set up a demonstration, which frequently is a required step in the sales process. In embodiments, scheduled demonstration data is retrieved from one of the LiveHive Activity Database or an external CRM.

5) New Proposals—In embodiments, qualifying processing unit 208 identifies a proposal, i.e., a document that comprises products or services that will be provided, the business terms of providing that product or service, and a price.

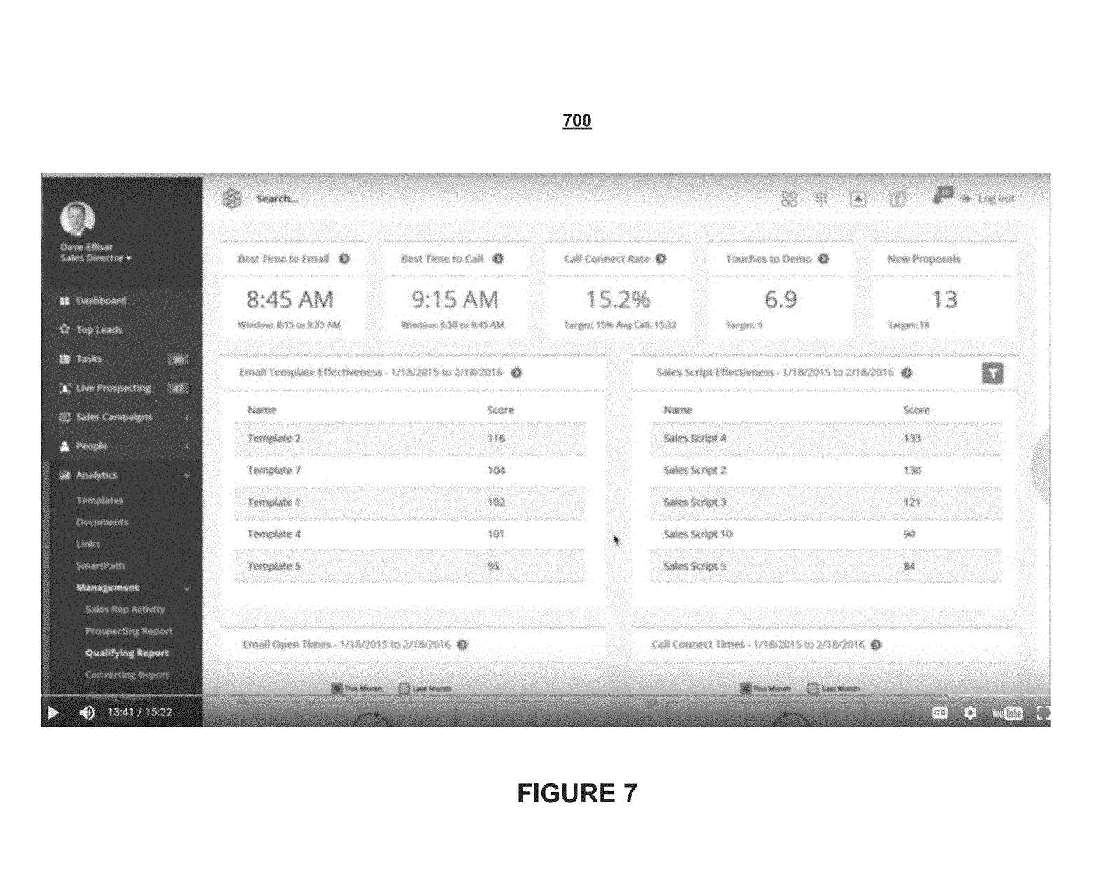

Sales Blueprint refers to an analysis of a sale that helps to identify the key elements that contributed to the success of a sale. In embodiments, sales blueprint creator 215 analyzes both salesperson activity records and sales prospect activity records associated with a customer to create graphical display, text, numerical information, or any combination thereof to identify factors, such as timeframe, (order of) activities, and the content of communication(s), that were involved in the sales process. The resulting sales blueprint may aid a sales team to repeat the process that resulted in the successful sale. An exemplary analytics qualifying report 700 generated according to various embodiments of the present disclosure using qualifying processing unit 208 is displayed in FIG. 7. In embodiments, analytics qualifying report 700 allows a sales manager to determine whether a sales team is qualifying enough prospects and which templates and scripts tend to be more effective than others.

Sales Coaching analytic refers to a measure of how well a salesperson executes tasks. In embodiments, sales coaching processing unit 214 is used to identify weak and strong points in a salesperson's sales technique with the goal of improving sales performance. Traditionally, the sales performance is evaluated by dollar amount of closed sales. While this is a valid metric, it does not help to identify why some salespeople succeed more often than others. In embodiments, sales coaching processing unit 214 generates performance scores based on the salesperson's activity records and prospect activity records (e.g., percent of emails opened by prospect and the percent of prospect that replied to an email). Sales coaching processing unit 214 may output a single score that represents an overall performance, or a breakdown of sales performance in different phases of the sales process workflow. In embodiments, sales coaching processing unit 214 uses one or more of the following metrics to evaluate sales performance:

1) Prospecting—The quantity of prospects a salesperson finds/adds to the system.

2) Qualifying—The percentage of prospects that are qualified.

3) Time to Qualify—The speed and efficiency with which a salesperson qualifies prospects relative to other salespersons.

4) Opportunities—The percentage of a salesperson's qualified prospects who become opportunities.

5) Time to Conversion—The speed and efficiency with which a salesperson converts prospects to opportunities.

6) Dollar Value of Opportunities—The economic value of a salesperson's opportunities.

7) Closed Sales—The percentage of completed sales.

8) Dollar Value of closed sales—The monetary value of completed sales.

In embodiments, one or more metrics may be used to obtain and display sales performance scores for individual salespersons and may be compared to scores of other salespersons, e.g., average performance scores of a sales team. A total score is determined from a weighted combination of a plurality of metrics. In embodiments, performance scores are used to identify a salesperson's areas of strength and weaknesses relative to the effectiveness of a sales team as a whole. It is understood that sale performance scores may be used to assign a rank to salespeople. Since sales efforts are more effective when salespeople respond relatively promptly to a prospect's indication of interest, detecting, scoring, and reporting a ranking of prospects based on both quantity and recent timing of activity is likely to improve the sales process.

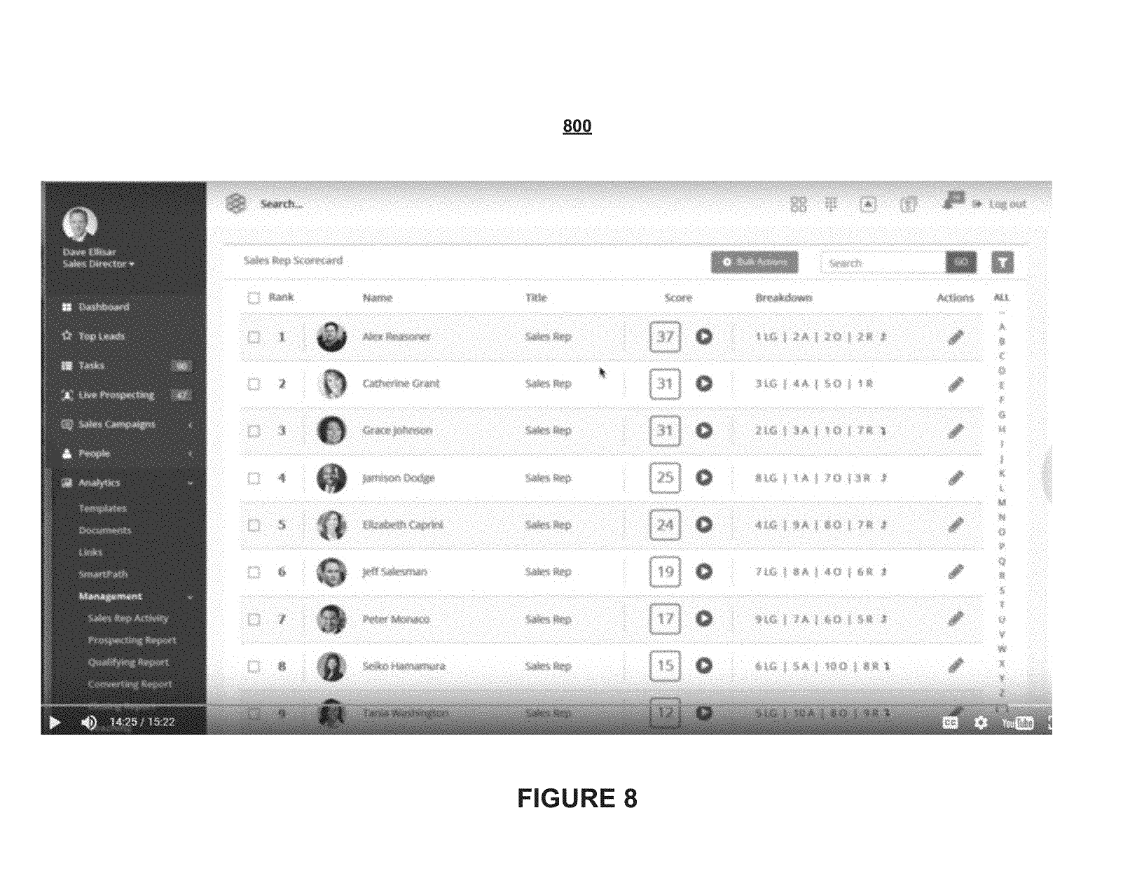

In embodiments, sales coaching processing unit 214 calculates scores on a regular basis (e.g., hourly) or on demand, and generates notifications that may be used to alert a sales manager, for example, whenever a particular metric for a salesperson falls outside a predetermined range. This makes the sales process workflow responsive to real-time events and allows sales managers to take corrective action, as needed, for example, to coach a salesperson who underperforms as measured by a particular metric. An exemplary report 800 generated according to various embodiments of the present disclosure using sales coaching processing unit 214 is displayed in FIG. 8. Analytics coaching report 800 depicts a performance score for each salesperson with the option to obtain additional detail about salespersons performances.

Sales Probability refers to a predictive score that represents the probability that an opportunity will become a closed sale. In embodiments, sales probability processing unit 210 utilizes sales activity data for Opportunity as well as metrics from previous successful sales with similar opportunity characteristics to generate a single number indicative of the probability for a successful sales close. An exemplary use of sales probability as one metric is shown in FIG. 5.

In embodiments, sales probability processing unit 210 receives from analytics database 230 data comprising similar opportunities. Similarity may be based on comparisons of factors such as company size, opportunity dollar value, type of industry, title of sales contact, time in the sales pipeline, responsiveness of key contacts within a company, and salesperson's estimate of the probability of closing. Opportunities that resulted in completed sales and sales that were lost may be both included. In embodiments, sales probability processing unit 210 uses a list of attributes to compare existing opportunities to similar opportunities. For each attribute sales probability processing unit 210 determines whether the attribute is closer to scores of completed sales deals or lost sales. A weighted combination of these attribute comparisons may then be converted into a final probability score.

Sales Campaign Effectiveness refers to an analysis of a multi-touch sales campaign. Sales campaign effectiveness processing unit 213 receives SmartPath Definitions and activity data from the salesperson and sales prospect activity records associated with SmartPath. In embodiments, sales campaign effectiveness processing unit 213 receives definitions of Email Templates and Call Scripts as inputs. Based on the inputs, sales campaign effectiveness processing unit 213 performs a graphical and/or numerical analysis to generate an output that highlights the effectiveness of each step in a sales campaign, for example, by identifying steps that are less effective than others and may, thus, be improved. In embodiments, the strength of a step is evaluated based on the responsiveness of prospects and/or other recipients (e.g., responsiveness to emails and phone calls).

In embodiments, sales campaign effectiveness processing unit 213 initiates notifications that may be used to alert a sales organization, e.g., in real-time, about steps that achieve a response rate that fall below a certain target response rate. As a result, the sales process workflow may be adjusted and improved, e.g., before more prospects are added to the work flow designed for a particular sales campaign.

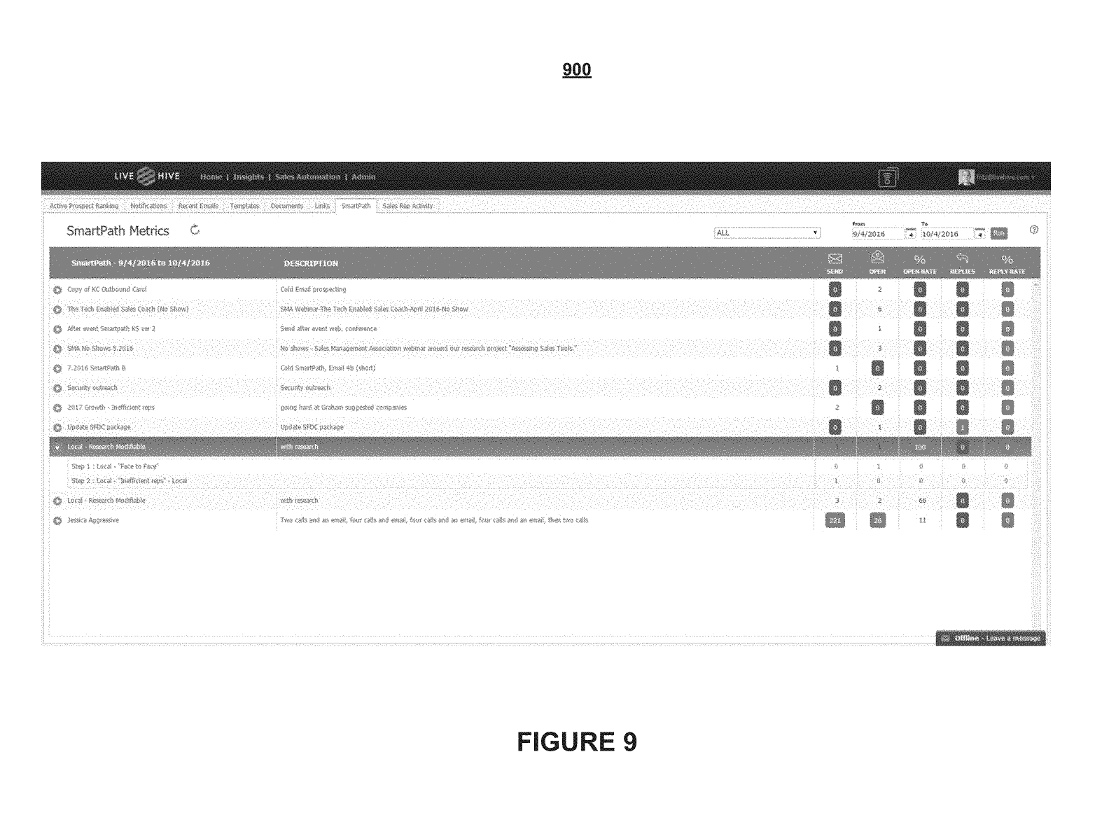

It is noted that analytics process 200 may utilize any combination of processing units, and remove or add processing units, e.g., a processing unit that evaluates the likelihood of an account being closed. An exemplary report 900 generated according to various embodiments of the present disclosure using sales campaign processing unit 213 is displayed in FIG. 9. Sales campaign effectiveness report 900 depicts the effectiveness of each sales campaign broken down by step, such steps that should be improved are readily identified.

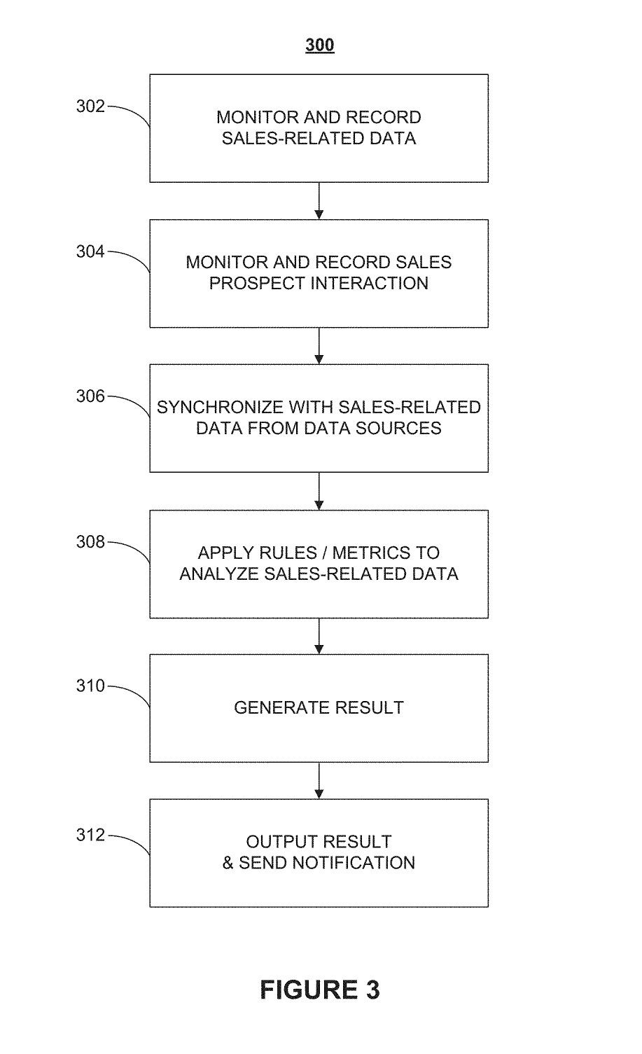

FIG. 3 is a flowchart of an illustrative process for analyzing a sales process workflow in accordance with various embodiments of the present disclosure. Process 300 begins at step 302 when sales-related data, such as email, phone call, and meeting information related to sales prospects and other recipients is monitored and recorded by a sales person activity recorder, for example, according to one or more data categories from one or more data sources.

At step 304, a sales prospect's interaction with a given type of communication is monitored and recorded, for example, by a prospect activity recorder that detects an email recipient's actions, such as opening an email, opening and/or viewing an attachment, sending a response email, or any combination thereof.

At step 306, sales-related data from one or more data sources, e.g., a SmartPath system and a CRM system are synchronized.

At step 308, based on at least the prospect's interaction, some or all of the data is analyzed by applying, in real-time, a set of rules or metrics to the data, e.g., to measure the quantity and quality of prospecting efforts by salespeople or categorize a prospect as an opportunity.

At step 310, based on the analysis, a result, such as a sales performance score, a progress report, or a ranking of prospects is generated.

At step 312, the result is output, e.g., on an interactive sales dashboard, and may serve as a basis for increasing sales productivity. In addition, a notification or alert regarding the result may be generated and communicated, e.g., to a sales manager.

It is noted that two or more steps 302-112 may be performed simultaneously and automatically. Aspects of the present patent document are directed to information handling systems. For purposes of this disclosure, an information handling system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data for business, scientific, control, or other purposes.

For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

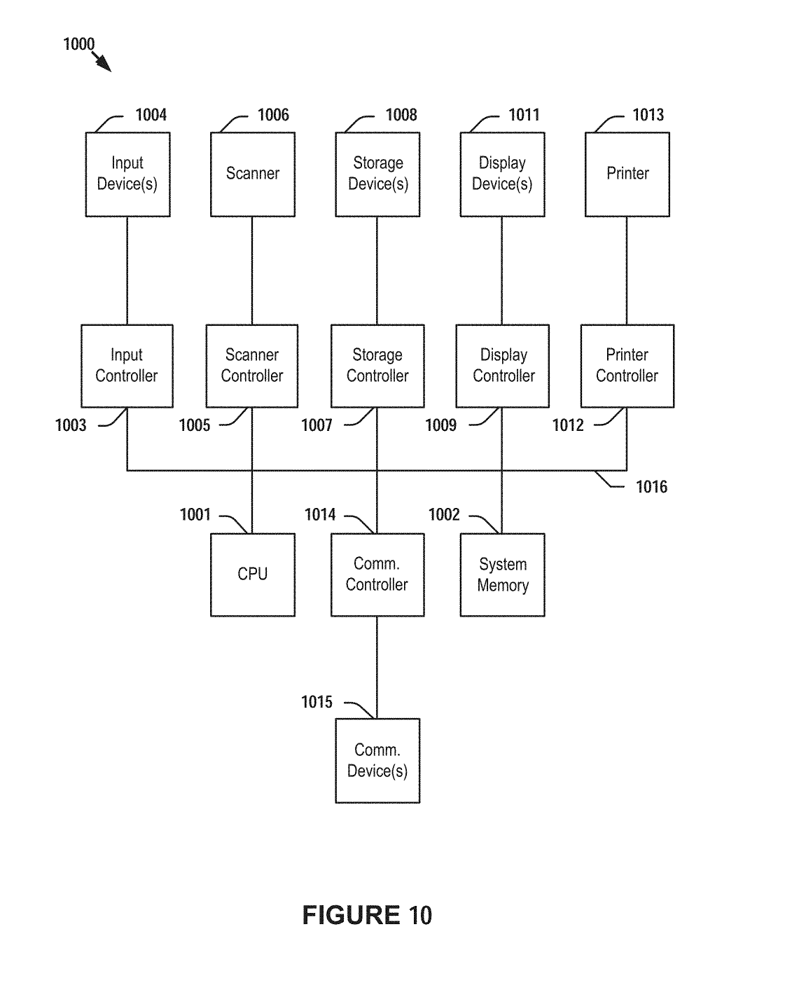

FIG. 10 depicts a block diagram of an information handling system 1000 according to embodiments of the present invention. It will be understood that the functionalities shown for system 1000 may operate to support various embodiments of an information handling system—although it shall be understood that an information handling system may be differently configured and include different components. As illustrated in FIG. 10, system 1000 includes a central processing unit (CPU) 1001 that provides computing resources and controls the computer. CPU 1001 may be implemented with a microprocessor or the like, and may also include a graphics processor and/or a floating point coprocessor for mathematical computations. System 1000 may also include a system memory 1002, which may be in the form of random-access memory (RAM) and read-only memory (ROM).

A number of controllers and peripheral devices may also be provided, as shown in FIG. 10. An input controller 1003 represents an interface to various input device(s) 1004, such as a keyboard, mouse, or stylus. There may also be a scanner controller 1005, which communicates with a scanner 1006. System 1000 may also include a storage controller 1007 for interfacing with one or more storage devices 1008 each of which includes a storage medium such as magnetic tape or disk, or an optical medium that might be used to record programs of instructions for operating systems, utilities and applications which may include embodiments of programs that implement various aspects of the present invention. Storage device(s) 1008 may also be used to store processed data or data to be processed in accordance with the invention. System 1000 may also include a display controller 1009 for providing an interface to a display device 1011, which may be a cathode ray tube (CRT), a thin film transistor (TFT) display, or other type of display. The computing system 1000 may also include a printer controller 1012 for communicating with a printer 1013. A communications controller 1014 may interface with one or more communication devices 1015, which enables system 1000 to connect to remote devices through any of a variety of networks including the Internet, an Ethernet cloud, a Fiber Channel over Ethernet (FCoE)/Data Center Bridging (DCB) cloud, a local area network (LAN), a wide area network (WAN), a storage area network (SAN) or through any suitable electromagnetic carrier signals including infrared signals.

In the illustrated system, all major system components may connect to a bus 1016, which may represent more than one physical bus. However, various system components may or may not be in physical proximity to one another. For example, input data and/or output data may be remotely transmitted from one physical location to another. In addition, programs that implement various aspects of this invention may be accessed from a remote location (e.g., a server) over a network. Such data and/or programs may be conveyed through any of a variety of machine-readable medium including, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices.

Embodiments of the present invention may be encoded upon one or more non-transitory computer-readable media with instructions for one or more processors or processing units to cause steps to be performed. It shall be noted that the one or more non-transitory computer-readable media shall include volatile and non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present invention may further relate to computer products with a non-transitory, tangible computer-readable medium that have computer code thereon for performing various computer-implemented operations. The media and computer code may be those specially designed and constructed for the purposes of the present invention, or they may be of the kind known or available to those having skill in the relevant arts. Examples of tangible computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that are executed by a computer using an interpreter. Embodiments of the present invention may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present invention. One skilled in the art will also recognize that a number of the elements described above may be physically and/or functionally separated into sub-modules or combined together.

It shall be noted that elements of the claims, below, may be arranged differently including having multiple dependencies, configurations, and combinations. For example, in embodiments, the subject matter of various claims may be combined with other claims.

It will be appreciated to those skilled in the art that the preceding examples and embodiment are exemplary and not limiting to the scope of the present invention. It is intended that all permutations, enhancements, equivalents, combinations, and improvements thereto that are apparent to those skilled in the art upon a reading of the specification and a study of the drawings are included within the true spirit and scope of the present invention.

What is claimed is:

1. A method for analyzing a sales process workflow to increase sales productivity, the method comprising:
monitoring and recording sales-related data according to one or more data categories from one or more data sources;
monitoring and recording an interaction associated with a sales prospect;
synchronizing sales-related data from one or more data sources;
based on at least the interaction, analyzing some or all of the data to obtain a result; and
outputting the result.

2. The method according to claim 1, wherein the result comprises at least one of a sales performance score, a progress report, or a ranking of prospects is generated.

3. The method according to claim 1, wherein the sales-related data comprises data related to at least one of a sales prospect and a recipient.

4. The method according to claim 3, wherein analyzing comprises applying at least one of a set of rules and a set of metrics to the data to perform a real-time analysis.

5. The method according to claim 1, further comprising detecting an action that has been performed by an email recipient.

6. The method according to claim 4, wherein the action comprises at least one of opening an email, opening an attachment, viewing an attachment, and sending a response email.

7. The method according to claim 1, wherein analyzing comprises at least one of measuring a prospecting effort by one or more salespeople and categorizing a prospect as an opportunity.

8. The method according to claim 1, further comprising generating at least one of a notification and an alert regarding the result.

9. A system for analyzing a sales process workflow to increasing sales productivity, the system comprising:
a sales person activity recorder that monitors and records sales-related data according to one or more data categories from one or more data sources;
a prospect activity recorder coupled to the sales person activity recorder, the prospect activity recorder monitors and records an interaction associated with a sales prospect; and
an analytics processor coupled to the sales person activity recorder, the analytics processor synchronizes sales-related data from one or more data sources, and analyzes, based on at least the interaction, some or all of the data to obtain a result, the analytics processor generates and outputs, based on the analysis, a result that comprises at least one of a progress report, a ranking of prospects, and a sales performance score.

10. The system according to claim 9, wherein the sales person activity detects an action that has been performed by an email recipient, the action comprising at least one of opening an email, opening an attachment, viewing an attachment, and sending a response email.

11. The system according to claim 9, wherein the analytics processor applies at least one of a set of rules and a set of metrics to the data to perform a real-time analysis.

12. The system according to claim 9, wherein the analytics processor measures a prospecting effort by one or more salespeople and categorizes a prospect as an opportunity.

13. The system according to claim 9, wherein the analytics processor generates at least one of a notification and an alert regarding the result.

14. A system for analyzing a sales process workflow to increase sales productivity, the system comprising:
one or more processors; and
a non-transitory computer-readable medium or media comprising one or more sequences of instructions which, when executed by at least one of the one or more processors, causes steps to be performed comprising:
monitoring and recording sales-related data according to one or more data categories from one or more data sources;
monitoring and recording an interaction associated with a sales prospect;
synchronizing sales-related data from one or more data sources;
based on at least the interaction, analyzing some or all of the data to obtain a result, the result comprising at least one of a progress report, a ranking of prospects, and a sales performance score; and
outputting the result.

15. The system according to claim 14, wherein the sales person activity detects an action that has been performed by an email recipient, the action comprising at least one of opening an email, opening an attachment, viewing an attachment, and sending a response email.

16. The system according to claim 14, wherein the analytics processor measures a prospecting effort by one or more salespeople and categorizes a prospect as an opportunity.

17. The system according to claim 14, wherein the analytics processor generates at least one of a notification and an alert regarding the result.

18. The system according to claim 14, wherein the analytics processor generates at least one of a notification and an alert regarding the result.

19. The system according to claim 14, wherein the analytics processor applies a set of rules to the data to perform a real-time analysis.

20. The system according to claim 14, wherein the analytics processor applies a set of metrics to the data to perform a real-time analysis.
